(19) United States
(12) Patent Application Publication
(10) Pub. No.: US 2014/0025301 A1
(43) Pub. Date: Jan. 23, 2014

(54) DETERMINATION OF SUBSURFACE PROPERTIES OF A WELL

(71) Applicants: Bruce H. Storm, JR., Houston, TX (US); Barry Fen Zhang, Houston, TX (US); Charles Perry Matula, Washington, TX (US)

(72) Inventors: Bruce H. Storm, JR., Houston, TX (US); Barry Fen Zhang, Houston, TX (US); Charles Perry Matula, Washington, TX (US)

(21) Appl. No.: 13/554,430

(22) Filed: Jul. 20, 2012

(51) Int. Cl. E21B 49/00; G06F 19/00

(52) U.S. Cl. 702/6; 73/152.02

(57) ABSTRACT

Embodiments of the present invention provide techniques for using data from a select set of wells to develop correlations between surface-measured properties and properties typically determined from subsurface measurements (e.g., from logging tool responses, core analysis, or other subsurface measurements). When new wells are drilled, the surface data acquired while drilling may be used as an input to these correlations in order to predict properties associated with subsurface measurements.

### BACKGROUND OF THE INVENTION

1. Field of the Invention

Embodiments of the present invention generally relate to producing hydrocarbons from a well and, more particularly, to making operational decisions about the well based on the determination of subsurface properties of a well without wellbore logging tools.

2. Description of the Related Art

Modern petroleum drilling and production operations demand a great quantity of information relating to parameters and conditions downhole. Such information typically includes characteristics of the earth formations traversed by the wellbore, in addition to data relating to the size and configuration of the borehole itself. Oil well logging has been known in the industry for many years as a technique for providing information to a formation evaluation professional or driller regarding the particular earth formation being drilled. The most sought-after information relates to the location and accessibility of hydrocarbon gases and fluids. In other words, logs may be used to make operational decisions about the well, to correlate formation depths with surrounding wells, and to make interpretations about the quantity and quality of hydrocarbons present.

The collection of information relating to conditions downhole, which commonly is referred to as “logging,” can be performed by several methods. These methods include measurement while drilling (MWD) and logging while drilling (LWD), in which a logging tool is carried on a drill string during the drilling process. The methods also include wireline logging. Generally, during the well-drilling process, or shortly thereafter, instruments are passed through the wellbore to collect information about the formations through which the wellbore passes.

In conventional oil well wireline logging, a probe or “sonde” is lowered into the borehole after some or all of the well has been drilled, and is used to determine certain characteristics of the formations traversed by the borehole. The sonde may include one or more sensors to measure parameters downhole and typically is constructed as a hermetically sealed cylinder for housing the sensors, which hangs at the end of a long cable or “wireline.” The cable or wireline provides mechanical support to the sonde and also provides electrical connections between the sensors and associated instrumentation within the sonde, and electrical equipment located at the surface of the well. Normally, the cable supplies operating power to the sonde and is used as an electrical conductor to transmit information signals from the sonde to the surface. In accordance with conventional techniques, various parameters of the earth's formations are measured and correlated with the position of the sonde in the borehole as the sonde is pulled uphole.

A chart or plot of an earth parameter or of a logging tool signal versus the position or depth in the borehole is called a “log.” The depth may be the distance from the surface of the earth to the location of the tool in the borehole or may be true depth, which may be the same only for a perfectly vertical straight borehole. The log of the tool signal or raw data often does not provide a clear representation of the earth parameter which the formation evaluation professional or driller needs to know. The tool signal must usually be processed to produce a log which more clearly represents a desired parameter. The log is normally first created in digital form by a computer and stored in computer memory, on tape, disk, etc. and may be displayed on a computer screen or printed in hard copy form.

The sensors used in a wireline sonde usually include a source device for transmitting energy into the formation, and one or more receivers for detecting the energy reflected from the formation. Various sensors have been used to determine particular characteristics of the formation, including nuclear sensors, acoustic sensors, and electrical sensors.

Porosity, permeability, and fluid content have proven to be particularly useful for determining the location of hydrocarbon gases and fluids. Porosity is the proportion of fluid-filled space found within the rock. It is this space that contains the oil and gas. Permeability is the ability of fluids to flow through the rock. The higher the porosity, the higher the possible oil and gas content of a rock reservoir. The higher the permeability, the easier for the oil and gas to flow toward the wellbore. Logging tools provide measurements that allow for the mathematical interpretation of these quantities.

Beyond just the porosity and permeability, various logging measurements allow the interpretation of what kinds of fluids are in the pores (e.g., oil, gas, brine). In addition, the logging measurements may be used to determine mechanical properties of the formations. These mechanical properties determine what kind of enhanced recovery methods may be used (e.g., tertiary recovery) and what damage to the formation (such as erosion) is to be expected during oil and gas production.

There are risks involved with utilizing logging tools downhole, particularly in deviated or horizontal wells. For example, logging tools are sometimes trapped downhole by collapsing wellbore walls. In the case of radioisotopic source tools, the trapping of a tool poses particular cause for concern. Moreover, by the time operational decisions about a well are made based on information from logging tools, the well may already be completed. Traditionally, samples from coring tools are taken to a laboratory for determining parameters such as porosity and permeability. By the time that decisions are made based on these parameters, it may be too late to make changes in the drilling of the well. Utilizing logging tools may also drive up the cost of a well.

### SUMMARY OF THE INVENTION

Embodiments of the present invention generally provide techniques for using data acquired wholly or substantially from data which may be collected from measurements made at the surface of a wellbore to predict select reservoir properties without requiring wellbore logs.

One embodiment of the present invention provides a method for determining a reservoir property. The method generally includes determining properties from one or more measurements performed at a surface of a first wellbore, determining properties from one or more measurements performed below the surface of the first wellbore, and determining correlations between the measurements performed at the surface of the first wellbore and the measurements performed below the surface of the first wellbore.

Another embodiment of the present invention provides a computer-program product for determining a reservoir property. The computer-program product generally includes a computer-readable medium having code for determining properties from one or more measurements performed at a surface of a first wellbore, determining properties from one or more measurements performed below the surface of the first wellbore, and determining correlations between the measurements performed at the surface of the first wellbore and the measurements performed below the surface of the first wellbore.

Yet another embodiment of the present invention provides a system for determining a reservoir property. The system generally includes a first wellbore and instrumentation. The instrumentation is typically configured to determine properties from one or more measurements performed at a surface of the first wellbore, determine properties from one or more measurements performed below the surface of the first wellbore, and determine correlations between the measurements performed at the surface of the first wellbore and the measurements performed below the surface of the first wellbore.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is an illustrative view of a LWD environment, according to an embodiment of the present invention.

FIG. 2 is an illustrative view of a wireline logging environment, according to an embodiment of the present invention.

FIG. 3 illustrates a transformation process for converting surface measurements into synthetic well logs, according to an embodiment of the present invention.

FIG. 4 illustrates example operations for using surface measurements of a well to predict associated subsurface measurements without requiring logging tools, according to an embodiment of the present invention.

FIG. 5 illustrates a neural network, according to an embodiment of the present invention.

FIG. 6 illustrates a computer system, according to an embodiment of the present invention.

### DETAILED DESCRIPTION

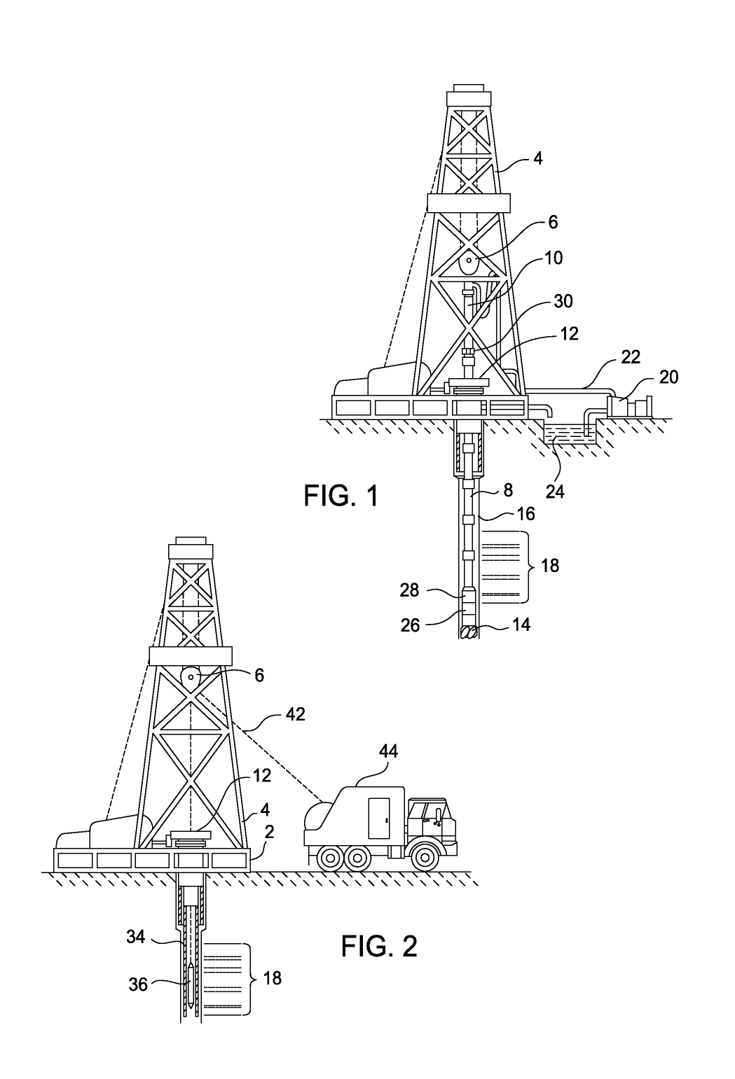

FIG. 1 shows an illustrative environment for drilling a well. A drilling platform 2 supports a derrick 4 having a traveling block 6 for raising and lowering a drill string 8. A kelly 10 supports the drill string 8 as it is lowered through a rotary table 12. A drill bit 14 is driven by a downhole motor and/or rotation of the drill string 8. As the bit 14 rotates, it creates a wellbore 16 that passes through various formations 18. A pump 20 circulates drilling fluid through a feed pipe 22 to kelly 10, through the interior of drill string 8, through orifices in drill bit 14, back to the surface via the annulus around drill string 8, and into a retention pit 24. The drilling fluid transports cuttings from the wellbore into the pit 24.

One or more LWD instruments are integrated into a logging tool 26 located near the bit 14. As the bit extends the wellbore through the formations, logging tool 26 collects measurements relating to various formation properties as well as the bit position and various other drilling conditions. The logging tool 26 may take the form of a drill collar, i.e., a thick-walled tubular that provides weight and rigidity to aid the drilling process. A telemetry sub 28 may be included to transfer tool measurements to a surface receiver 30 and to receive commands from the surface receiver.

Once a well has been drilled, the wellbore 16 may be lined with casing 34 as shown in FIG. 2 to preserve the integrity of the hole and to prevent fluid loss into porous formations along the borehole path. Typically, the casing is permanently cemented into place to maximize the borehole's longevity and to prevent unwanted fluid communication between formations. Subsequent logging operations may be conducted using a wireline logging tool 36, i.e., a sensing instrument sonde suspended by a cable 42 having conductors for transporting power to the tool and telemetry from the tool to the surface. A logging facility 44 collects measurements from the logging tool 36, and typically includes computing facilities for processing and storing the measurements gathered by the logging tool.

The logging information is intended to characterize formations 18 so as to locate reservoirs of oil, gas, or other underground fluids, and so as to provide data for use in field correlation studies and to assist in seismic data interpretation. Whenever possible, logging is performed in uncased (“open hole”) conditions because the logging tool can achieve closer contact with the formation and because some of the desired open hole measurements are adversely affected by the casing and/or cement in a cased borehole. However, the open hole logging environment is somewhat more hostile than the cased hole environment, since the wellbore has less integrity. For example, logging tools are often trapped downhole by collapsing wellbore walls, as mentioned above. In the case of radioisotopic source tools, the trapping of a tool poses particular cause for concern.

Moreover, by the time operational decisions about a well are made based on information from logging tools, the well may already be completed. Traditionally, samples from coring tools are taken to a laboratory for determining parameters such as porosity and permeability. By the time that decisions are made based on these parameters, it may be too late to make changes in the drilling of the well. In view of the risk, time, and costs involved with running and utilizing logging tools downhole, it is desirable to reduce the use of logging tools. However, it is particularly desirable to have the information provided by logging tools in order to make operational decisions.

Embodiments of the present invention provide techniques for using surface measurements (e.g., data acquired wholly or substantially from data which may be collected from measurements made at the surface) to predict select reservoir properties (e.g., density, porosity, permeability, brittleness) without requiring wireline logging (WL), LWD, or other wellbore logs. This may reduce the number of WL, LWD, or other wellbore logs which may be run in a field, alleviating or reducing the risk, time, and cost associated with running logging tools. For certain embodiments, synthetic well logs may be constructed from the surface measurements. Therefore, logging tools may be used in a limited number of “training” wells to set a baseline from which synthetic well logs may be generated for other wells. The predicted responses (e.g., from the synthetic well logs) may be used in steering other wells, or in assisting completion decisions such as casing point, perforation, or stimulation placement.

For the purposes of this invention, “the surface” is meant to denote at least areas accessible without entering the wellbore. Examples of the surface may include the surface of the earth, the surface of the sea floor, or the surface of the ocean. “Surface data” is taken to mean data which may be acquired from measurements made substantially from the surface. This data may be indicative of subsurface properties or conditions. “Logs”, “logging tools”, “logging tool responses”, and related terms are meant to denote subsurface measurements of formation or fluid properties, independent of the method of conveyance (e.g., wireline, slickline, drillpipe, coiled tubing, etc.) or the time at which the measurement is made in the course of drilling and completing the well.

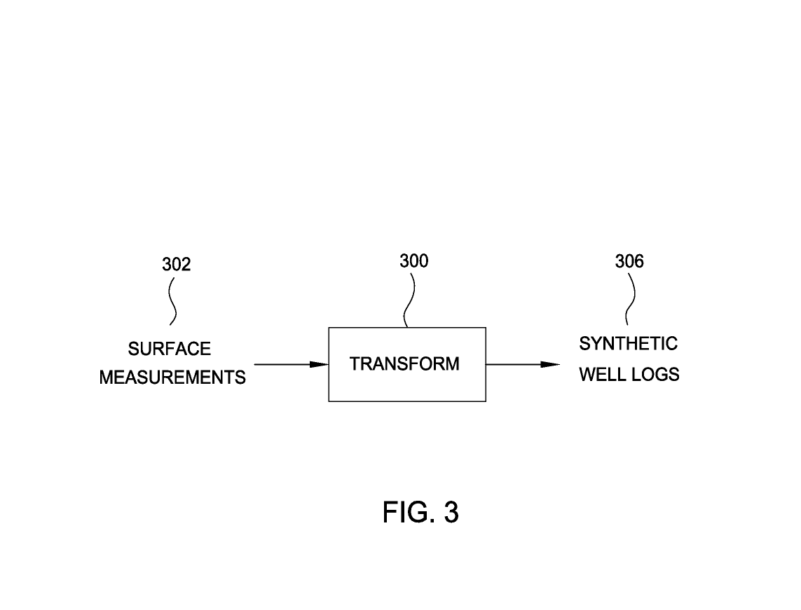

FIG. 3 illustrates a transformation process 300 for converting surface measurements 302 (i.e., input data) into synthetic well logs 306 (i.e., output data). Transform block 300 may employ correlation algorithm(s) to perform the conversion (e.g., neural networks and/or genetic algorithms), as will be further discussed. For some embodiments, the transform block 300 may employ multiple neural networks that are combined in an ensemble to provide more robust behavior both within and outside the training region. For some embodiments, a subset of inputs and a subset of outputs may be used to develop correlations and/or to predict properties.

The term “input” is used to describe the set of parameters which are typically measured at the surface and may be used together with the correlation algorithm(s) to predict other parameters (e.g., synthetic well log 306). Examples of surface measurements include, but are not limited to, data from mud logs, drilling dynamics, and micro-seismic and seismic surveys. Data from mud logs generally include mud type, mud weight, viscosity, and fluid composition. Hydrocarbon analysis generally includes the analysis of total organic carbon, kerogen content, and hydrogen index. Cuttings analysis generally includes elemental composition, facies analysis, kerogen content, and total organic carbon. Data from drilling dynamics generally includes weight on bit (WOB), rate of penetration (ROP), torque on bit, vibration, bit type, bit diameter, caliper, and downhole temperature and pressure. Data from seismic surveys generally include the determination of faults, fractures, and geological layers.

In addition to the measurements which are currently available for analysis of drilling fluids and cuttings, embodiments of the present invention provide for the analysis of cuttings for naturally occurring radioactive materials. Analysis of the cuttings generally includes the capture and preparation of cuttings at the surface (e.g., the removal of fluid, pressing into sample pucks, and weighing the sample) and measuring the nuclear spectra. Measured count rates for uranium (U), potassium (K), and thorium (T) may be presented as well as rates normalized by the sample mass. As a result, a synthetic gamma ray curve may be constructed from the cuttings by tying the U, K, T count rates to the well depth from which the cuttings originated.

The term “output” is used to describe the set of parameters which are typically measured subsurface, or are not generally available in real-time while drilling, and may be used to develop the correlations. The term output also describes the set of measurements that may be predicted using one or more inputs and the correlation algorithm(s). Output data generally includes density, porosity, shear and compressional velocity, resistivity, nuclear magnetic resonance (NMR), and natural gamma ray measurements. Output data from core analysis generally includes permeability, composition (mineral and elemental), and reservoir properties (e.g., moduli, brittleness, facies). Output data may consist of a composite index (e.g., optimal stimulation placement, natural fracture location, fracture index) which may be calculated from a combination of measured parameters. Output data may include production histories, Young's modulus, Poisson's ratio, or anisotropy.

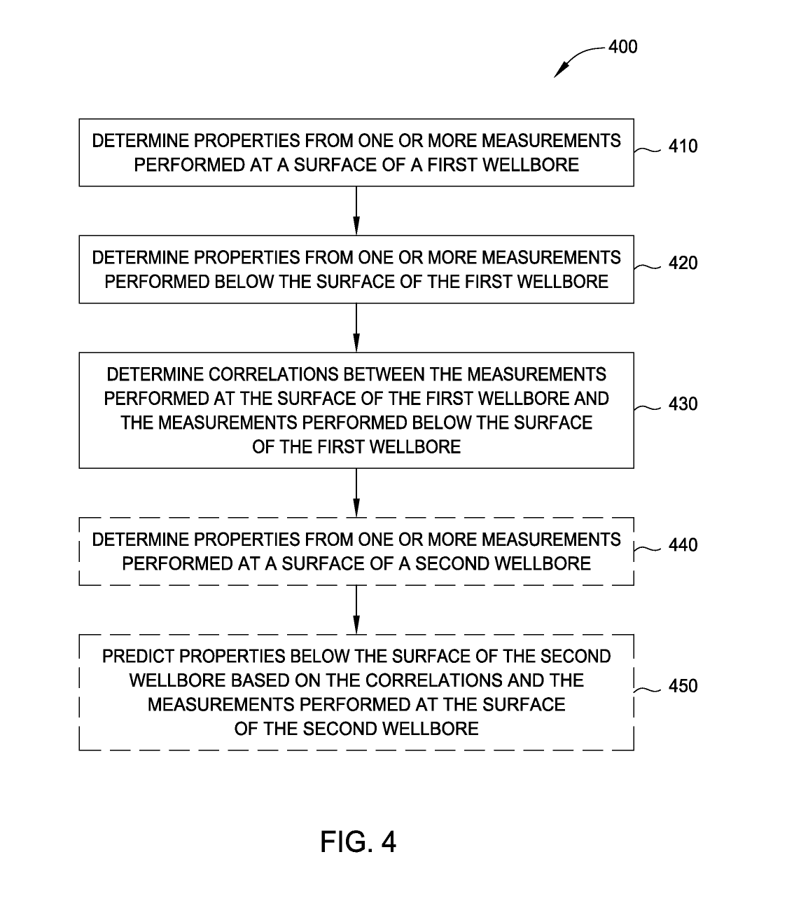

FIG. 4 illustrates example operations 400 for using surface measurements of a well to predict associated subsurface measurements without requiring logging tools, according to an embodiment of the present invention. The operations 400 may be performed, for example, by at least one processor disposed locally at a well or remotely, for example, at a gathering center. At 410, the processor may determine properties from one or more measurements performed at a surface of a first wellbore (e.g., surface measurements 302 of a training wellbore).

At 420, the processor may determine properties from one or more measurements performed below the surface of the first wellbore. Examples of the subsurface measurements generally include the output data discussed above, such as density, porosity, permeability, rock hardness, or rock brittleness.

At 430, the processor may determine correlations between the measurements performed at the surface of the first wellbore and the measurements performed below the surface of the first wellbore. Other data may be included in developing the correlations. For example, core or seismic data may be included as inputs in the correlation development phase, and rock hardness or brittleness may be predicted properties. In order to identify correlations between inputs such as drilling dynamics data and mud log data, and outputs such as logs and core analysis, the processor may employ neural networks and/or genetic algorithms to determine the correlations, although other algorithms known in the art may be used.

Optionally, at 440, the processor may determine properties from one or more measurements performed at a surface of a second wellbore (e.g., development wellbore). At 450, the processor may predict properties below the surface of the second wellbore based on the correlations and the measurements performed at the surface of the second wellbore, wherein the properties below the surface of the second wellbore may be used to make operational decisions for the second wellbore. Such operational decisions may include wellbore placement, perforation placement, stimulation placement, or casing setting points.

For some embodiments, a combination of inputs may be considered in developing an accurate correlation algorithm. For example, elemental composition alone may not be sufficient to determine bulk reservoir properties. For example, a rock comprised of calcium carbonate may exhibit a range of porosities. As porosity increases, the ROP may increase relative to that in a lower porosity, assuming other kinematic variables (e.g., WOB, RPM, torque, etc.) remain the same. By measuring a combination of inputs, such as the elemental composition as well as the drilling dynamics parameters, a unique correlation may be determined for porosity.

Such correlations may be expected to be valid in a particular field where the depositional environment is the same for each well. For example, when porosity changes, drilling dynamics may change for a given elemental composition. Correlations developed for a particular field may be applied to other fields, but the level of uncertainty associated with the predicted values may increase. For certain embodiments, the correlations may be established from a well or group of wells (e.g., training wells with logging tools) and the method applied to the surrounding wells (e.g., development wells without logging tools). As a result, this may reduce the number of WL, LWD, or other wellbore logs which may be run in a field, alleviating or reducing the risk, time, and cost associated with running logging tools.

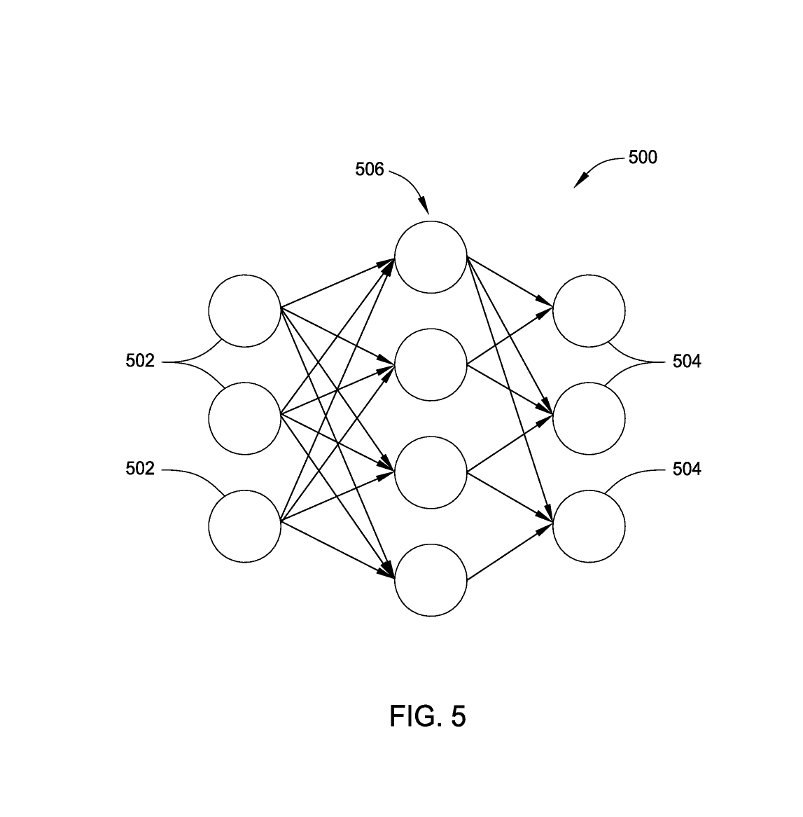

FIG. 5 illustrates a simplified neural network 500. The neural network 500 generally includes a plurality of input nodes 502. Input nodes 502 are the points within the neural network that the data is provided for further processing (e.g., surface measurements 302 in FIG. 3). Moreover, the neural network 500 generally includes one or more output nodes 504. Each output node 504 may represent a calculated and/or predicted parameter based on the input data at the input nodes 502 (e.g., synthetic well logs 306). Between the input nodes 502 and the output nodes 504 are one or more layers of hidden nodes 506. As shown in FIG. 5, the hidden nodes 506 may be coupled to some, or all, of the input nodes 502. Likewise, the hidden nodes 506 may be coupled to some, or all, of the output nodes 504. Each of the hidden nodes 506 may perform a mathematical function that is determined or learned during a training phase of the neural network 500 (e.g., transformation process 300 in FIG. 3; step 430 in FIG. 4). While the illustrative FIG. 5 shows three input nodes 502, three output nodes 504, and four hidden nodes 506, any number of input nodes 502 and output nodes 504 may be used respectively. Likewise, any number of hidden nodes 506, and multiple layers of hidden nodes 506, may be used to implement the neural network.

The neural networks do not inherently know how to calculate and/or estimate predicted parameters, and thus training of the neural network is needed. The training may take many forms depending on the situation and the type of data available. As illustrated in FIG. 4, measurements performed at a surface of a first wellbore may be input into the neural network 500, and the hidden nodes 506 may train the neural network 500 to yield the measurements performed below the surface of the first wellbore with logging tools. Thereafter, the neural network 500 may be utilized to predict properties below the surface of a second wellbore without logging tools, based on measurements performed at a surface of the second wellbore.

Embodiments of the present invention provide methods for using data from a select set of wells to develop correlations between surface-measured properties and properties typically determined from subsurface measurements (e.g., from logging tool responses, core analysis, or other subsurface measurements). When new wells are drilled, the surface data acquired while drilling may be used as an input to these correlations in order to predict properties associated with subsurface measurements.

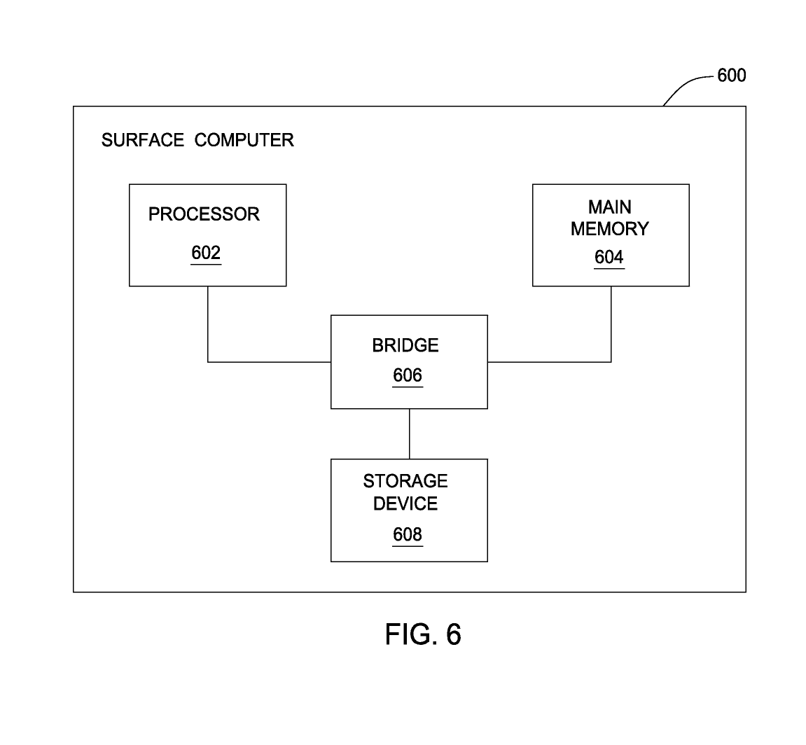

In accordance with at least some embodiments, the processing to predict the one or more subsurface measurements of a development well may be performed, for example, by a surface computer. FIG. 6 illustrates in greater detail a surface computer 600. The surface computer 600 may be proximate to the borehole or located at the central office of the oilfield services company. The central computer 600 generally includes a processor 602, and the processor 602 couples to a main memory 604 by way of a bridge device 606. Moreover, the processor 602 may couple to a long term storage device 608 (e.g., a hard drive) by way of the bridge device 606. Programs executable by the processor 602 may be stored on the long term storage device 608, and accessed when needed by the processor 602. The program stored on the long term storage device 608 may comprise programs to implement the various embodiments of the present specification, including programs to implement the correlation algorithms (e.g., artificial neural networks and/or genetic algorithms). In some cases, the programs may be copied from the long term storage device 608 to the main memory 604, and the programs may be executed from the main memory 604. The subsurface measurements predicted by the surface computer 600 may be sent to a plotter that creates a paper-log, or the geophysical parameters may be sent to a computer screen which may make a representation of the log for viewing by a geologist or other person skilled in the art of interpreting such logs.

In one or more exemplary embodiments, the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The above discussion is meant to be illustrative of the principles and various embodiments of the present invention. Numerous variations and modifications will become apparent to those skilled in the art. For example, though individual neural networks are illustrated in the various drawings, it will be understood that ensembles of neural networks may be equivalently used, particularly in situations where multiple subsurface measurements are being estimated for any particular borehole depth. Moreover, in some embodiments, the neural network processing may be performed contemporaneously with the gathering of the data by a logging tool (e.g., in a training well). In the contemporaneous situations, the surface computer 600 may not only control the logging tool, but may also collect and perform the neural network-based processing of the data to produce the various logs.

While the foregoing is directed to embodiments of the present invention, other and further embodiments of the invention may be devised without departing from the basic scope thereof, and the scope thereof is determined by the claims that follow.

1. A method for determining a reservoir property, the method comprising:
determining properties from one or more measurements performed at a surface of a first wellbore;
determining properties from one or more measurements performed below the surface of the first wellbore; and
determining correlations between the measurements performed at the surface of the first wellbore and the measurements performed below the surface of the first wellbore.

2. The method of claim 1, further comprising:
determining properties from one or more measurements performed at a surface of a second wellbore; and
predicting properties below the surface of the second wellbore based on the correlations and the measurements performed at the surface of the second wellbore.

3. The method of claim 2, wherein the properties below the surface of the second wellbore are used to make operational decisions of the second wellbore.

4. The method of claim 3, wherein the operational decisions comprise at least wellbore placement, perforation placement, stimulation placement, or a casing setting point.

5. The method of claim 2, wherein the properties from the measurements performed at the surfaces of the first or second wellbores comprise at least properties associated with mud logs, drilling dynamics, or seismic surveys.

6. The method of claim 2, wherein the properties below the surfaces of the first or second wellbores comprise at least density, porosity, permeability, rock hardness, or rock brittleness.

7. The method of claim 2, further comprising:
constructing a synthetic well log of the second wellbore based on the correlations and the measurements performed at the surface of the second wellbore.

8. The method of claim 2, wherein the measurements performed at the surfaces of the first or second wellbores are determined from cuttings recovered from below the surfaces of the wellbores.

9. The method of claim 8, wherein the measurements determined from the cuttings recovered from below the surfaces of the wellbores comprises:
removing fluids from the cuttings;
weighing the cuttings; and
measuring a nuclear spectra of the cuttings.

10. The method of claim 1, wherein determining the correlations comprises using neural networks or genetic algorithms.

11. The method of claim 2, wherein the first wellbore is a training wellbore and the second wellbore is a development wellbore.

12. A computer-program product for determining a reservoir property, the computer-program product comprising:
a computer-readable medium having code for:
determining properties from one or more measurements performed at a surface of a first wellbore;
determining properties from one or more measurements performed below the surface of the first wellbore; and
determining correlations between the measurements performed at the surface of the first wellbore and the measurements performed below the surface of the first wellbore.

13. The computer-program product of claim 12, further comprising code for:
determining properties from one or more measurements performed at a surface of a second wellbore; and
predicting properties below the surface of the second wellbore based on the correlations and the measurements performed at the surface of the second wellbore.

14. The computer-program product of claim 13, wherein the properties below the surface of the second wellbore are used to make operational decisions of the second wellbore.

15. The computer-program product of claim 13, further comprising code for:
constructing a synthetic well log of the second wellbore based on the correlations and the measurements performed at the surface of the second wellbore.

16. The computer-program product of claim 12, wherein the code for determining the correlations comprises code for using neural networks or genetic algorithms.

17. A system for determining a reservoir property, the system comprising:
a first wellbore; and
instrumentation configured to:
determine properties from one or more measurements performed at a surface of the first wellbore;
determine properties from one or more measurements performed below the surface of the first wellbore; and
determine correlations between the measurements performed at the surface of the first wellbore and the measurements performed below the surface of the first wellbore.

18. The system of claim 17, further comprising:
a second wellbore, wherein the instrumentation is configured to:
determine properties from one or more measurements performed at a surface of a second wellbore; and
predict properties below the surface of the second wellbore based on the correlations and the measurements performed at the surface of the second wellbore.

19. The system of claim 18, wherein the properties below the surface of the second wellbore are used to make operational decisions of the second wellbore.

20. The system of claim 18, wherein the first wellbore is a training wellbore and the second wellbore is a development wellbore.
